(19) United States
(12) Patent Application Publication
(10) Pub. No.: US 2020/0316727 A1
(43) Pub. Date: Oct. 8, 2020

(54) WELDING ASSEMBLY, WELDING PLANT AND METHOD FOR WELDING

(71) Applicant: Corimpex S.R.L., Paese (IT)

(72) Inventor: Paolo STORER, Paese (IT)

(73) Assignee: Corimpex S.R.L., Paese (IT)

(21) Appl. No.: 16/649,691

(22) PCT Filed: Sep. 11, 2018
(86) PCT No.: PCT/IT2018/050166

§ 371 Date: Mar. 23, 2020

(30) Foreign Application Priority Data
Sep. 21, 2017 (IT) 102017000105530

(51) Int. Cl. B23K 37/04; B23K 37/047; B23K 37/00

(52) U.S. Cl. CPC B23K 37/0461; B23K 9/18; B23K 37/00; B23K 37/047

(57) ABSTRACT

Described is a welding assembly (104) designed to be positioned in line between first rollers (101) and second rollers (103) of a plant (100) for the welding of steel beams with an H profile starting from a first flange (6), a web (7) and a second flange (8) to be welded together, characterised in that it is designed to rotate about itself by 180° about a relative vertical axis, in such a way as to receive the web (7), the first flange (6) and/or the second flange (8), both when coming from the first rollers (101) and when coming from the second rollers (103). The invention also relates to a relative plant (100) for the welding and a method for its operation.

This invention applies to the submerged arc welding sector. More specifically, the invention relates to an automated submerged arc welding plant, aimed at the steel construction industry.

In more detail, the invention relates to a plant for welding steel beams with a T or H profile.

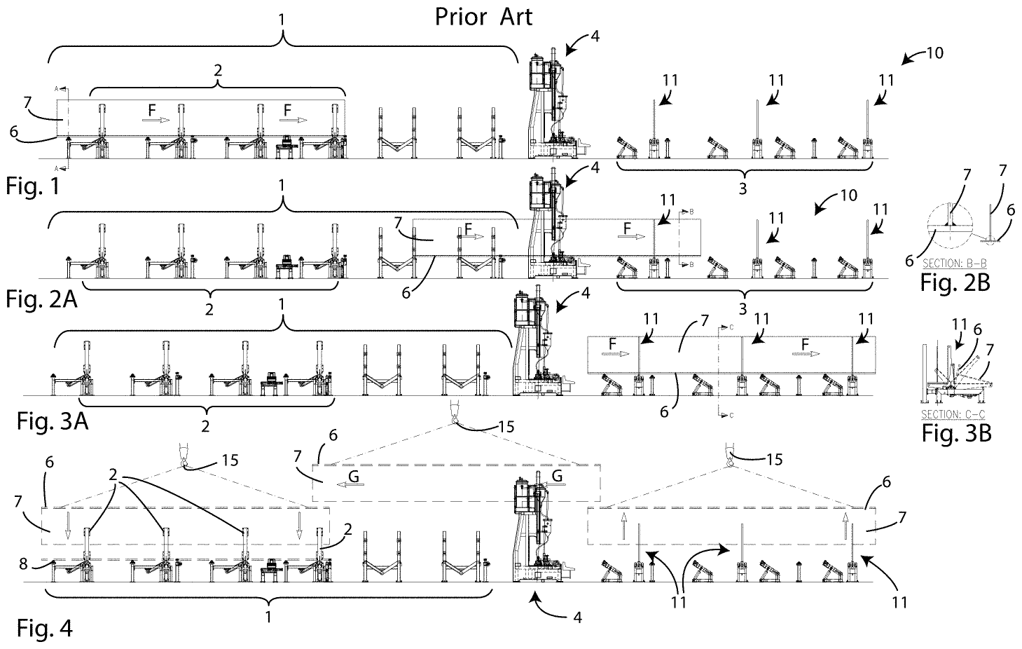

Plants for welding H beams are currently present on the market comprising several apparatuses together, making it necessary to use a gantry crane in almost all the stages of the process for assembling and handling a partially made profile (FIGS. 1-7 attached).

In short, the use of an area of approximately 400 m2 is needed for housing a plant 10 comprising: the infeed rollers 1 with the support cages 2, the outfeed rollers 3, the welding assembly 4 and the gantry crane 5 in front of them.

In fact, in order to make beams with an H profile, a first flange 6 is initially positioned on the infeed rollers 1, the web 7 is arranged perpendicularly and centrally to the flange 6, these two elements 6 and 7 are blocked in their reciprocal position by the support cages 2, and the two elements 6 and 7 are slid towards the welding assembly 4 (in the direction of the arrow F). As the two elements 6 and 7 slide on the infeed rollers 1 towards the welding assembly 4, the welding assembly 4 carries out, by means of the welding heads 9, the two welds at the two joining edges between the flange 6 and the web 7.

After completion of the welding of the above-mentioned elements 6 and 7, the T profile obtained in this way (comprising a single flange 6 and the web 7) is turned over, and the attachment system 15 of the gantry crane 5 then picks up the T profile and places it again on a new flange 8 on the infeed rollers 1, moving it in the direction of the arrows G, opposite to the arrows F.

At this point, the steps described above are repeated until the welding of the second flange 8 to the web 7 along the two joining edges.

However, as well as the need for a significant production space for housing the gantry crane as well as the plant, the current system has a certain degree of danger during the step for tilting the T profile, as it is complex to control.

Another risk of accidents occurs during the step for transferring the T profile by means of the gantry crane 5, from the tilting means 11 of the outfeed rollers 3 to the infeed rollers 1.

Moreover, a drawback is given by the noise exceeding 85 Decibels during the step for tilting the T profile.

A further drawback is given by the wear of the tilting levers made of steel, which require frequent maintenance.

Since the movement by means of the gantry crane requires a certain time, the productivity of the plant is adversely affected, with obvious down times. Yet another drawback is due to the fact that the control of so many apparatuses is so complex that it requires the presence on the production line of three operators.

There is therefore the need on the market for a welding plant for beams with an H profile with a high productivity, without down times and which allows the production space available to be optimised.

A welding assembly, that could be considered relevant prior art, closest to the subject-matter of the appended claim 1 is known from: CN104014900, CN104308333 and CN103567678.

The aim of the plant and the method according to the invention is to overcome the above-mentioned drawbacks and obtain a production plant and a relative method which is efficient from the point of view of production times and the space occupied, as well as for the control of the risk of accidents during their use.

The object of the invention is therefore a welding assembly designed to be positioned in line between first rollers and second rollers of a plant for the welding of steel beams with an H profile (starting from a first flange, a web and a second flange to be welded together).

The invention provides for the welding assembly to rotate about itself on a support surface by 180° about a relative vertical axis (perpendicular to the support surface), in such a way as to receive the web, the first flange and/or the second flange, both when coming from the first infeed rollers and when coming from the second outfeed rollers.

Preferably, the invention can comprise chain operated tilting means, for tilting the first flange and the web by 180° on the second rollers with precision and control of the movement, without requiring the intervention of an operator.

Another advantage is given by the reduction of the noise and the risk of accidents, because the movement of the beam is controlled and accurate. Moreover, the invention can also comprise suspension means equipped with hydraulic telescopic arms, to keep suspended in position the first flange and/or the web when in movement, after tilting.

This allows, advantageously, the operations for centering and alignment of the web on the second flange to be performed in an easy and safe manner.

Another object of the invention is a plant for the welding of steel beams with an H profile (which can be made as described above), comprising first rollers and second rollers and the above-mentioned welding assembly positioned in line between the first rollers and second rollers.

Advantageously, therefore, it is possible to eliminate the presence of the gantry crane and to move the beam simply by means of the rollers themselves; consequently with a considerable reduction in space, as well as a reduction in time.

According to the invention, the plant can comprise support cages for supporting and centring the web with respect to the first flange, each equipped with a hydraulic clamp for their actuation. In this way, the force exerted is not only greater but also uniform along the entire beam, facilitating the alignment and centring operations.

Another object of the invention is a method for welding steel beams with an H profile starting from a first flange, a web and a second flange, characterised in that it comprises the following steps:

receiving the first flange on first rollers

positioning the web perpendicularly to the first flange and centrally with respect to it (in this obtaining a beam with a T profile, given by the first flange and by the web)

passing the T profile (where the term “T profile” means the above-mentioned beam, which has a cross section with such a profile) inside a welding assembly and simultaneously welding the first flange to the web

resting the T profile on second rollers

tilting the T profile by 180° with respect to a horizontal plane

rotating the welding assembly by 180° about its vertical axis

inserting the second flange beneath the turned T profile, positioning the web perpendicular to the second flange and centrally with respect to it (in this way, a beam is obtained with an H profile given by the first flange, the second flange and the web)

passing the H profile inside the welding assembly rotated in this way and simultaneously welding the second flange to the web.

The method advantageously allows the production to be considerably reduced, eliminating the down time due to the transport by means of the gantry crane of the T beam in the intermediate processing step.

Further characteristics and advantages of the plant and the method, according to the invention, will more fully emerge from the description that follows, relative to a preferred embodiment thereof given by way of non-limiting example, and from the appended drawings, in which:

FIG. 1 is a schematic front view of a production line, in a first step, according to the prior art;

FIG. 2A is a schematic front view of the production line of FIG. 1, in a second step;

FIG. 2B is a cross-section of a detail of FIG. 2A;

FIG. 3A is a schematic front view of the production line of FIG. 1, in a third step;

FIG. 3B is a cross section of a detail of FIG. 3A, with tilting means shown in the initial position with a continuous line and in intermediate positions with a dashed line;

FIG. 4 is a schematic front view of the production line of FIG. 1, in a fourth step, with welding elements shown in intermediate positions with a dashed line;

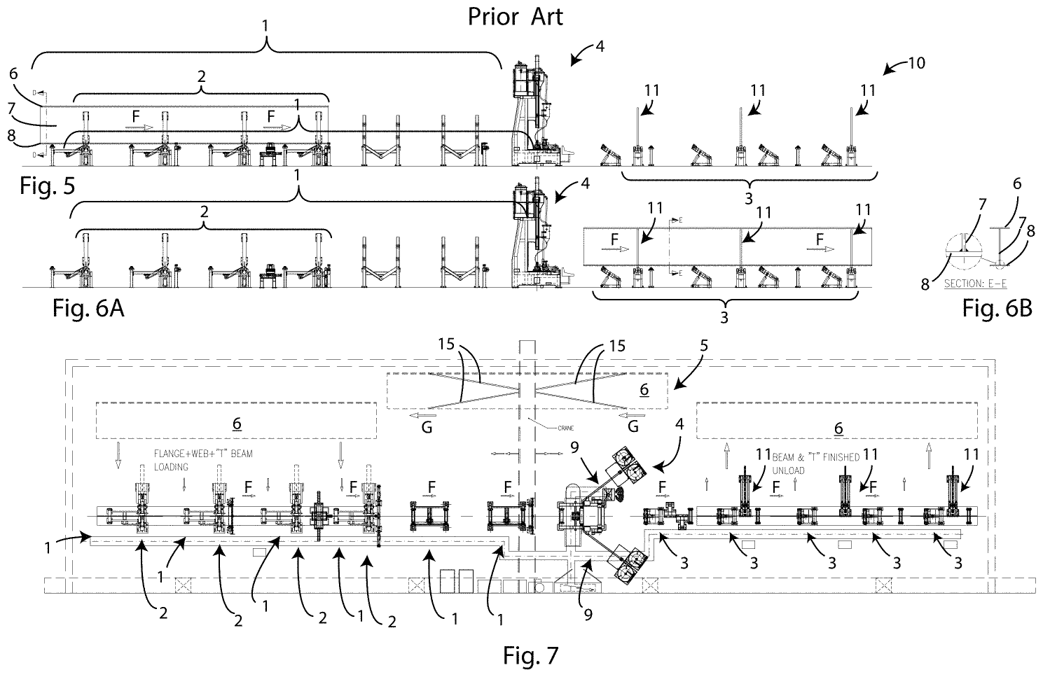

FIG. 5 is a schematic front view of the production line of FIG. 1, in a fifth step;

FIG. 6A is a schematic front view of the production line of FIG. 1, in a sixth step;

FIG. 6B is a cross-section of a detail of FIG. 6A;

FIG. 7 is a top view of the production line of FIG. 1, with gantry crane and the elements to be welded shown in intermediate positions with a dashed line;

FIG. 8 is a schematic front view of a production line, in a first step, according to the invention;

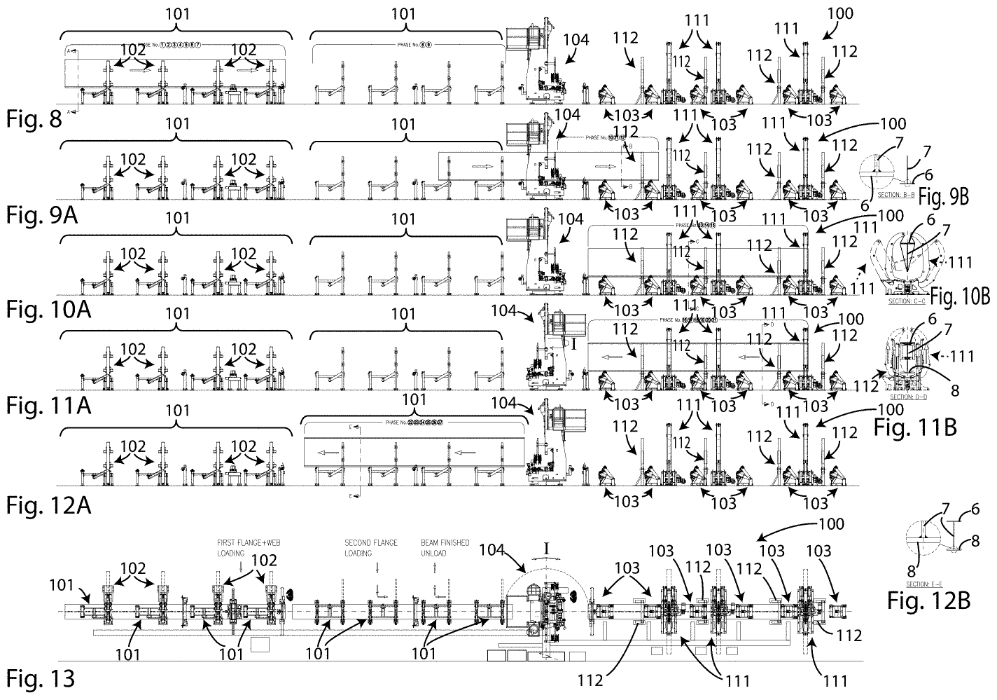

FIG. 9A is a schematic front view of the production line of FIG. 8, in a second step;

FIG. 9B is a cross-section of a detail of FIG. 9A;

FIG. 10A is a schematic front view of the production line of FIG. 8, in a third step;

FIG. 10B is a cross section of a detail of FIG. 10A, with tilting means and elements to be welded shown in the final position with a continuous line and in intermediate positions with a dashed line;

FIG. 11A is a schematic front view of the production line of FIG. 8, in a fourth step;

FIG. 11B is a cross section of a detail of FIG. 11A, with lifting means and elements to be welded shown in the final position with a continuous line and the tilting means shown with a dashed line;

FIG. 12A is a schematic front view of the production line of FIG. 8, in a fifth step;

FIG. 12B is a cross-section of a detail of FIG. 12A;

FIG. 13 is a top view of the plant of FIG. 8;

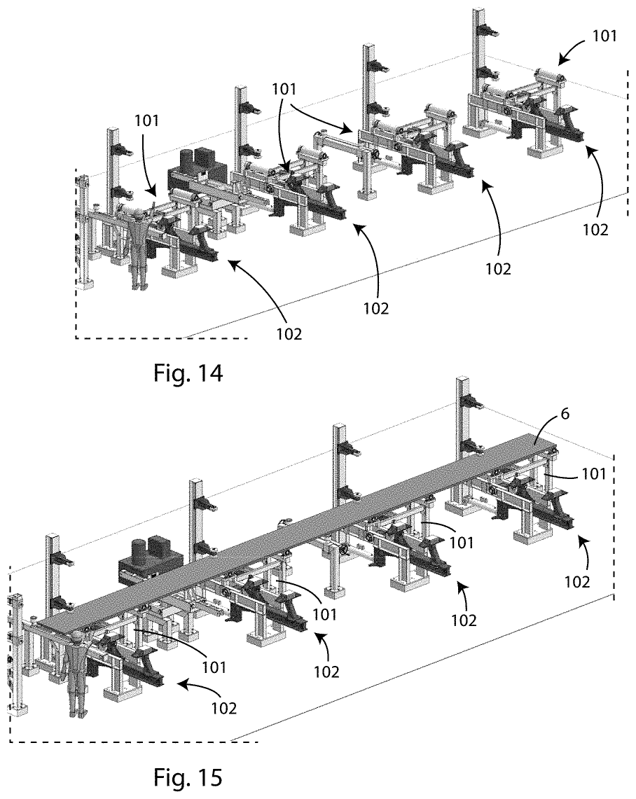

FIG. 14 shows a first detail of the plant of FIG. 8, unloaded;

FIG. 15 shows the detail of FIG. 14, with a first element loaded;

FIG. 16 shows the detail of FIG. 14, with a second element loaded;

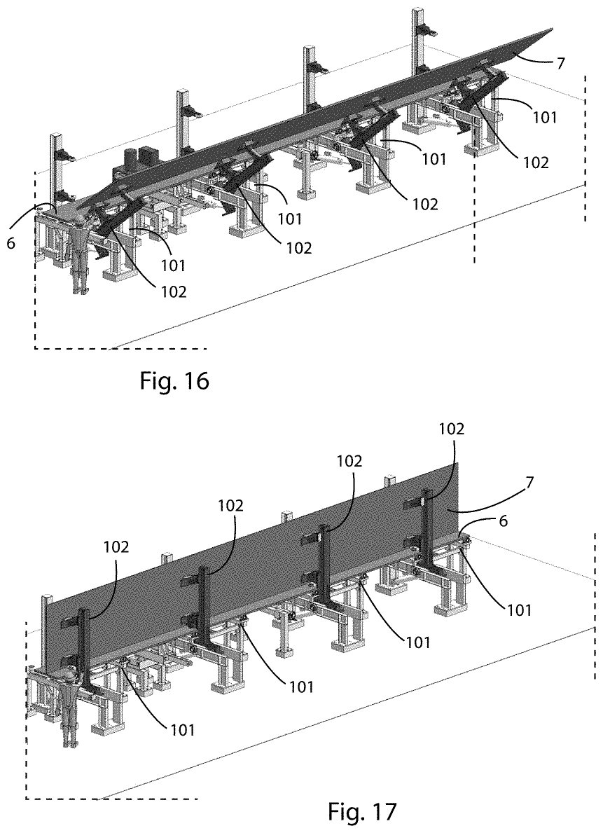

FIG. 17 shows the detail of FIG. 16, with a cages closed;

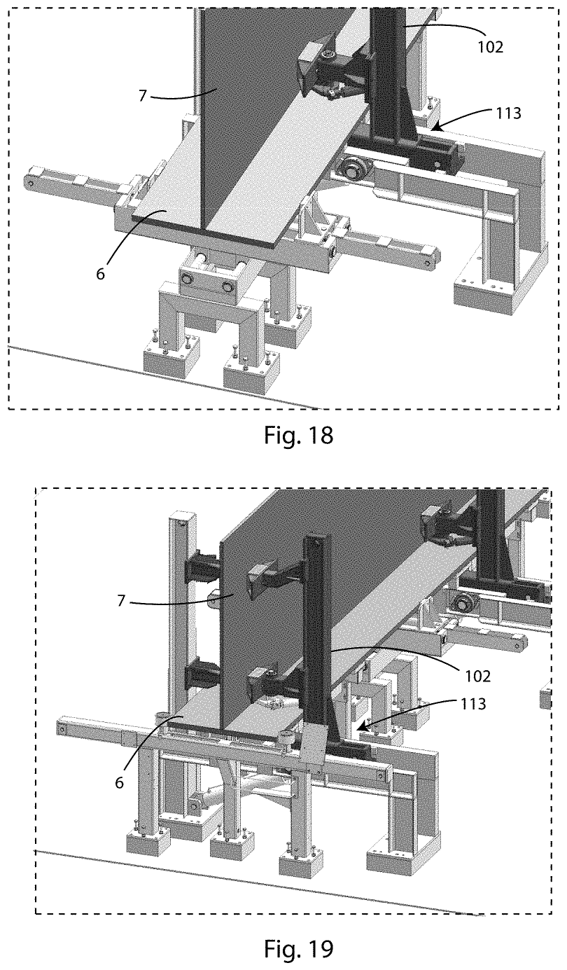

FIG. 18 shows an enlargement of FIG. 17;

FIG. 19 shows the enlargement of FIG. 18, with hydraulic clamp actuated;

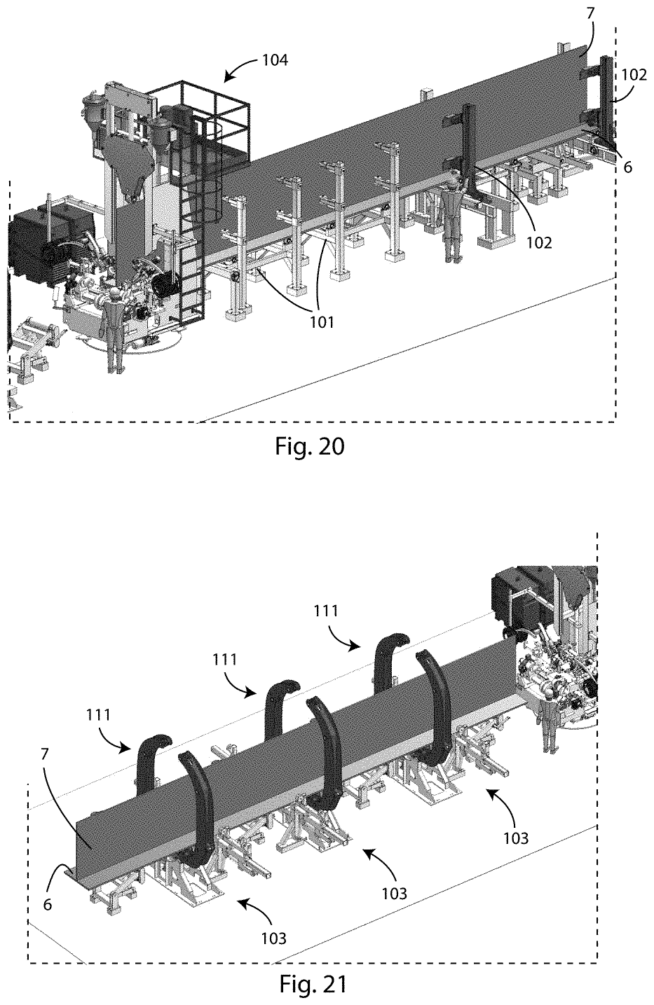

FIG. 20 shows a second detail of the production line of FIG. 8, with elements to be welded entering the welding assembly;

FIG. 21 shows a third detail of the plant of FIG. 8, with elements to be welded in a first position;

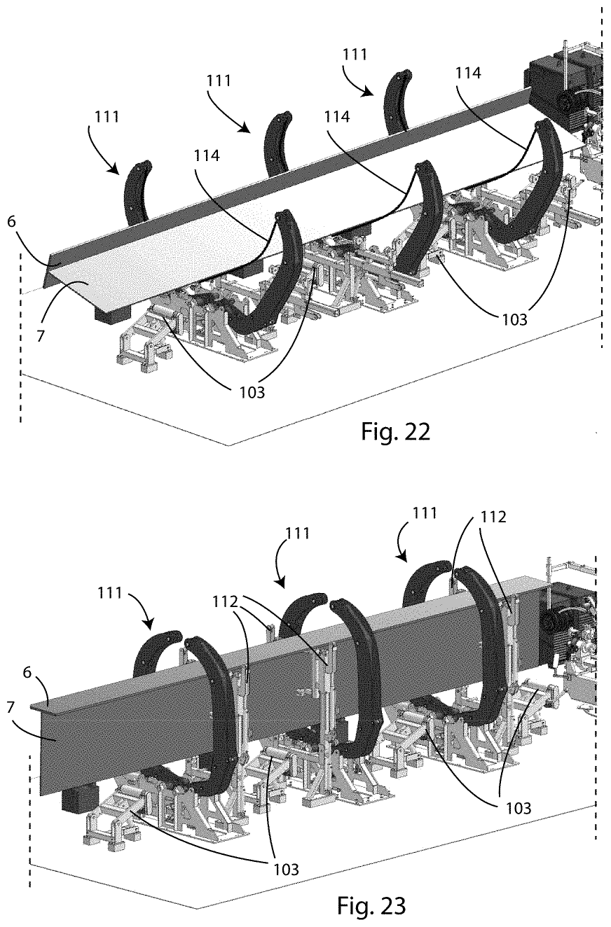

FIG. 22 shows the detail of FIG. 21, with elements to be welded in a second position;

FIG. 23 shows the detail of FIG. 21, with elements to be welded in a third position;

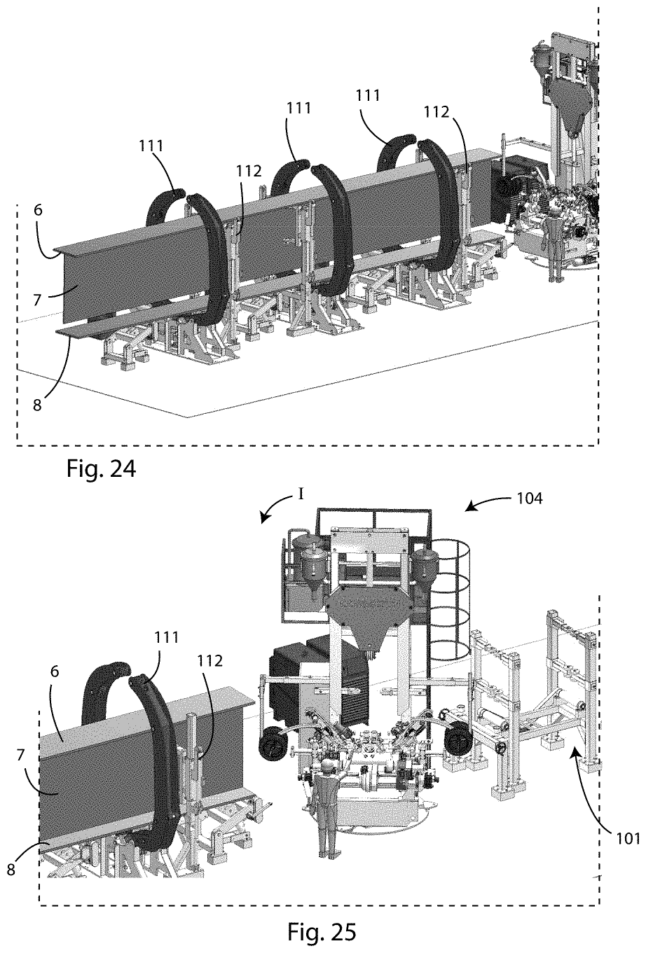

FIG. 24 shows the detail of FIG. 21, with elements to be welded in a fourth position;

FIG. 25 shows a fourth detail of the plant of FIG. 8, with welding assembly rotating;

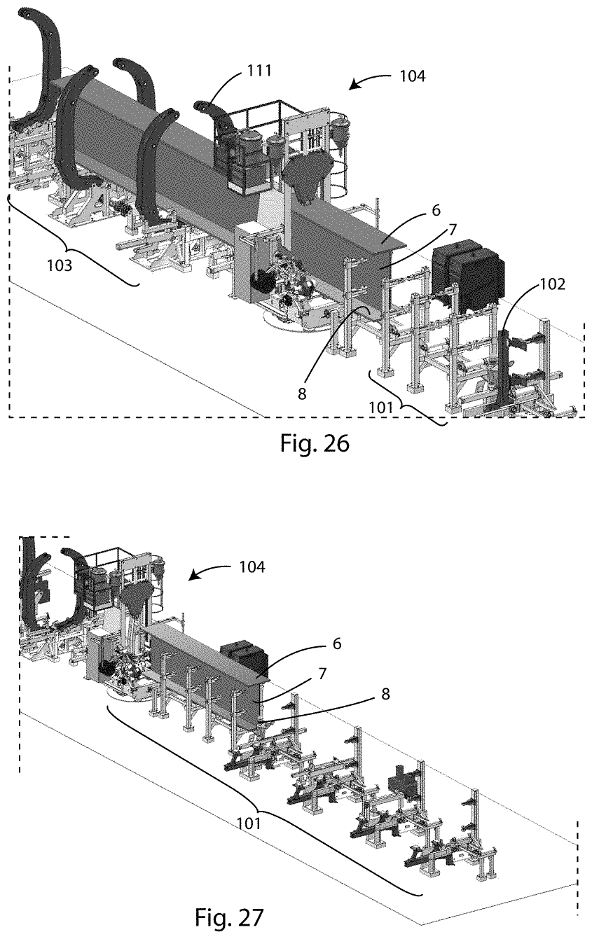

FIG. 26 shows a fifth detail of the plant of FIG. 8, with elements to be welded in the welding assembly;

FIG. 27 shows a sixth detail of the plant of FIG. 8, with elements welded.

With reference to the above-mentioned FIGS. 8-27, the plant 100 according to the invention comprises: first rollers 101, support cages 102, second rollers 103, preferably which can be raised, and a welding assembly 104 placed in line between the first rollers 101 and the second rollers 102.

The welding assembly 104, according to the invention, is able to rotate about itself by 180° about the relative vertical axis, in the direction of the arrows I (FIGS. 11 and 13). Advantageously, this allows the welding assembly 104 to receive a series of elements 6, 7, 8 to be welded together, coming both from the first rollers 101 and from the second rollers 103.

In this way it is possible, advantageously, to carry out the processing both in one direction and in the opposite direction, with obvious savings in time.

Preferably, the welding assembly 104 comprises chain operated tilting means 111 for tilting the T profile by 180° on the second rollers 103.

This guarantees, advantageously, the control and the precision of the movement, reducing the risk of accidents during tilting.

Another aspect of the invention relates to the possibility of keeping the T profile tilted in this way in position, on the second flange, using the suspension means 112 equipped with hydraulic telescopic arms, in such a way as to advantageously increase the stability of the elements to be welded, and reducing to a minimum the risks of unbalancing.

Operatively, with reference to FIGS. 14-27, the first rollers 101 are initially unloaded and the support cages 102, for supporting the webs 7 in position, are open (FIG. 14).

The loading operations start with the loading of the first flange 6 on the first rollers 101 (FIG. 15).

Once the first flange 6 is in position on the first rollers 101, the web 7 is positioned on the support cages 102 (FIG. 16) and they close (FIG. 17).

A preferred variant embodiment of the invention comprises a hydraulic clamp 113 for actuating the support cages 102, in such a way that the web 7 is aligned and centred correctly with respect to the first flange 6 (FIGS. 18-19).

Once the web 7 has been centred with respect to the flange 6, this set of elements forms a T, which is inserted in the welding assembly 104, and the welding of the T starts (FIG. 20), whilst this passes through the welding assembly and rests on the second rollers 103, raised.

After the first welding step has been completed, that is, when the T is resting completely on the second rollers 103, the latter lower downwards (FIG. 21), moving the first flange 6 into contact with the chains of the 114 tilting means 111.

When the tilting means 111 are actuated these open whilst the chains rotate in one direction, and the T is tipped initially by 90°, moving the first flange 6 in a substantially vertical position, and the web 7 in a substantially horizontal position, with the non-welded end of the web 7 in contact with the chains 114 of the tilting means 111 (FIG. 22).

When the tilting means 111 are closed, the chains 114 continue to rotate in the same direction, moving the first flange 6 upwards and the web 7 in a vertical position. The suspension means 112, preferably by means of the telescopic arms 116, therefore keep the first flange 6 perfectly horizontal and the entire T slightly suspended (FIG. 23).

In this position it is possible to insert beneath the T the second flange 8 (FIG. 24), and to centre in position the second flange 8 with respect to the web 7, in order to create an H profile.

The welding assembly 104 rotates about the relative vertical axis in the direction of the arrow I, by 180° (FIG. 25), in such a way as to receive the H profile coming from the second rollers 103.

The H profile may therefore move again towards the welding assembly 104 for the welding of the second flange 8 to the web 7 (FIG. 26), and then rest on the first rollers 101 (FIG. 27).

The invention described can be modified and adapted in several ways without thereby departing from the scope of the inventive concept.

Further, all the details can be replaced by other technically-equivalent elements.

Lastly, the components used, providing they are compatible with the specific use, as well as the dimensions, may vary according to requirements and the state of the art.

Where the characteristics and the techniques mentioned in the following claims are followed by reference signs, the reference signs have been used only with the aim of increasing the intelligibility of the claims themselves and, consequently, the reference signs do not constitute in any way a limitation to the interpretation of each element identified, purely by way of example, by the signs numbers.

1. Welding assembly (104), comprising two welding heads, suitable for being placed in line between first infeed rollers (101) and second outfeed rollers (103) of a plant (100) for welding steel beams with an H profile starting from a first flange (6), a web (7) and a second flange (8) to be welded together, characterized in that, the welding assembly (104) is suitable to rotate about itself 180°, about its vertical axis, in a way to receive the web (7) of said steel beams, the first flange (6) of said steel beams and/or the second flange (8) of said steel beams, either when coming from the first infeed rollers (101), or when coming from the second outfeed rollers (103), so that said welding assembly (104) can weld the web (7) of said steel beams, the first flange (6) of said steel beams and/or the second flange (8) of said steel beams both when coming from the first infeed rollers and when coming from the second outfeed rollers.

2. A welding assembly (104) according to claim 1, characterized in that it comprises chain operated tilting means (111), for turning the first flange (6) and the web (7) 180° on the second rollers (103).

3. A welding assembly (104) according to claim 1, characterized in that it comprises suspensions means (112) equipped with hydraulic telescopic arms, to maintain the flange (6) and/or the web (7) suspended in position.

4. Plant (100) for welding steel beams with an H profile, comprising first infeed rollers (101) and second outfeed rollers (103) over which the web (7) of said steel beams, the first flange (6) of said steel beams and/or the second flange (8) of said steel beams slide, characterized in comprising a welding assembly (104) according to claim 1 positioned in line between said first infeed rollers (101) and said outfeed rollers (103), the welding assembly (104) allowing to weld together a first flange of said steel beams (6), a web (7) of said steel beams, and a second flange of said steel beams 8).

5. Plant (100) according to claim 4, characterized in comprising support cages (102) for supporting and centering the web (7) with respect to the first flange (6), each having a hydraulic clamp (113) for operating said support cages (102).

6. A method for welding steel beams with an H profile from a first flange (6), a web (7) and a second flange (8), characterized in that it comprises the following steps:
receiving the first flange (6) on the first rollers (101);
positioning the web (7) perpendicular to the first flange (6) and centered with respect to it, so as to obtain a T profile comprising the first flange (6) and the web (7);
passing the T profile inside a welding assembly (104) and simultaneously weld the first flange (6) to the web (7);
laying the T profile on second rollers (103);
turning the T profile 180° with respect to a horizontal plane;
rotating the welding assembly (104) 180° about its vertical axis;
inserting the second flange (8) below the turned T profile, positioning the web (7) perpendicular to the second flange (8) and centered with respect to it, so as to obtain a H profile comprising the first flange (6), the second flange (8) and the web (7);
passing the H profile within the welding assembly (104) rotated and proceed simultaneously, welding the second flange (6) to the web (7).
